(19) United States
(12) Patent Application Publication
(10) Pub. No.: US 2018/0061426 A1
(43) Pub. Date: Mar. 1, 2018

(54) Method for decoding audio sequences

(71) Applicant: Anton Bilan, Westcliff-on-Sea (GB)

(72) Inventor: Anton Bilan, Westcliff-on-Sea (GB)

(21) Appl. No.: 15/253,909

(22) Filed: Sep. 1, 2016

(51) Int. Cl. G10L 19/022; G10L 19/16

(52) U.S. Cl. CPC G10L 19/022; G10L 19/167

(57) ABSTRACT

An application may combine encoded input audio data into overlapping blocks for decoding and then remove overlapping to remove otherwise present audible defects on borders between separately decoded non-overlapping consecutive audio data blocks.

### BACKGROUND OF THE INVENTION

In applications where the encoded audio data comes in consecutive blocks, for example, in live audio streaming or recorded audio playback over network, and needs to be decoded in real time while not all the data is yet available on the decoder side, the decoder can produce audible defects on the borders between separately decoded audio blocks.

### BRIEF SUMMARY OF THE INVENTION

Presented method allows to remove the audible defects on the borders between separately decoded consecutive audio blocks by creating overlapping in the encoded input audio data blocks and removing it afterwards from the decoded audio data blocks.

### BRIEF DESCRIPTION OF THE DRAWINGS

FIG. 1 depicts a standard process of decoding audio sequence block by block.

FIG. 2 is a flow chart illustrating the method for decoding audio sequences by creating overlapping in the encoded blocks first before the decoding process takes place, and then removing it from the produced decoded blocks.

### DETAILED DESCRIPTION OF THE INVENTION

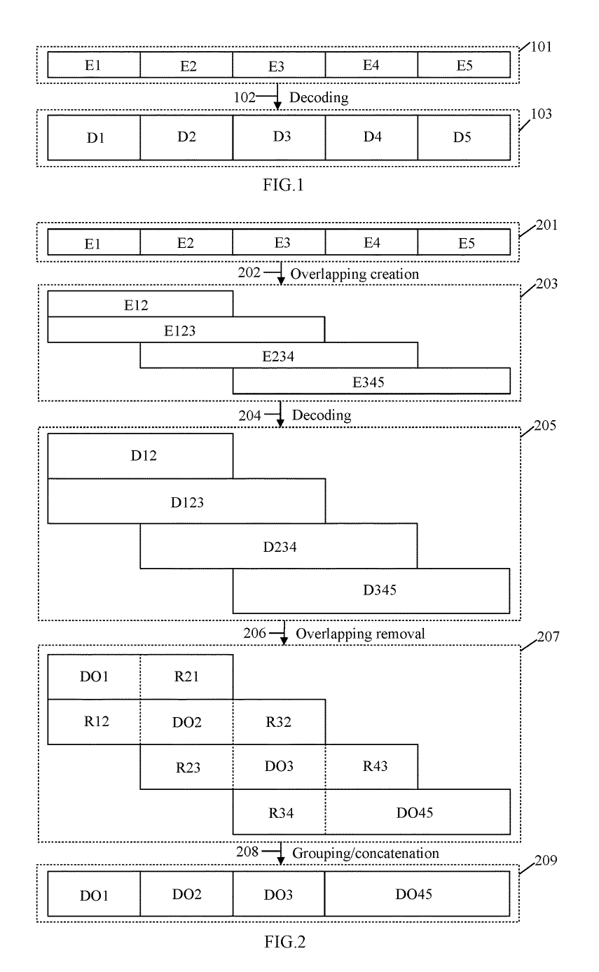

Some applications require to be able to start decoding of the compressed audio input without waiting for all the data to be received. When decoding consecutive blocks of the encoded audio part by part using a decoder, the result is often different from the one obtained by first combining all the blocks and decoding the audio data as a single piece: the decoded data on borders between the blocks is different from the decoded data in these places when decoded as a single piece, which results in audible defects. FIG. 1 depicts this process, five input consecutive encoded audio data blocks 101 labeled E1-E5 are put through the decoding process 102 one by one to obtain accordingly five output decoded audio blocks 103 labeled D1-D5.

To get the result identical to decoding the data as a single piece, in the presented method it is proposed to combine the input audio data in such a way that the produced blocks have overlapping data. The size of the overlapping audio data in the decoded state is first found by decoding the overlapping part only, by creating a copy of the input data E1-E5 block by block as they become available and using process identical to the one in FIG. 1.

Then, process in FIG. 2 takes place. First, the input audio blocks 201 are put though overlapping creation process 202 to produce encoded audio blocks with overlapping 203 labeled E12, E123, E234 and E345. The blocks are displayed one below the other to show the overlapping parts. Then these blocks are put through the decoding process 204 to produce decoded audio blocks with overlapping 205 labeled D12, D123, D234 and D345. These blocks are then truncated 206 to remove overlapping using block sizes obtained from process in FIG. 1, thus produced decoded audio blocks 207 labeled DO1-DO45 are then grouped or concatenated 208 to produce the final result 209, while overlapping labeled R21, R12, R32, R23, R43 and R34 is discarded.

The sequence of steps is as follows. Block E1 is received, a copy is created and is put through the decoder to obtain the size of this block in the decoded state. Block E2 is received, its size is obtained in the same way, then block E12 is created by concatenating E1 and E2, it is put through the decoder to obtain block D12, part E2 is removed by truncation to produce block DO1—the decoded output audio data that can be played back.

Block E3 is received, its size is obtained, then blocks E1, E2 and E3 are concatenated to create block E123, it is put though the decoder to obtain block D123, parts E1 and E3 are removed to produce suitable for playback block DO2.

The process is repeated until the last block E5 is received, it is concatenated with the two previous blocks E3 and E4 to create E345, it is put through the decoder to obtain block D345, part E3 is removed to produce the last block DO45.

Here it is assumed that the input data E1-E5 comes in smallest decodable blocks and thus overlapping is of the smallest size, otherwise it would be advisable to group(cut, copy and concatenate) data in a different way to reduce overlapping to lower computational costs of the decoding process of large overlapping audio parts that are eventually discarded.

It is also assumed that minimal latency is critical for the application. If is it not, more consecutive audio blocks can be concatenated by 202 prior to the decoding 204 and accordingly not all of the input blocks are put though the decoding process 102 because sizes of not all the blocks are necessary in this case. Also this reduce the overall overlapping size.

Produced in this way consecutive blocks of the decoded audio do not differ when concatenated from decoded audio data produced by decoding a single block made of concatenated input blocks and thus do not suffer from audible defects when played back.

In particular, this method is applicable in network applications such as live audio streaming or playback of recorded audio via network without waiting for the whole data to be downloaded first. In our tests we used HTTP and Web Sockets as the network protocols, decodeAudioData function of Web Audio API and FFmpeg as the decoders, audio data encoded using mp3 and aac audio codecs but it should be understood that the method is not limited to the said protocols, decoders and audio codecs.

What is claimed is:

1. A method for decoding consecutive audio data, the method comprising:
concatenating encoded input audio data blocks to form blocks with overlapping data;
determining the size of the overlapping data parts in the decoded state;
decoding the produced overlapping blocks using decoder;
removing overlapping parts of the said size from adjacent blocks of the decoded audio data, at the end of one block and at the beginning of the next block.

2. The method of claim 1, wherein the said decoder is a software decoder like Web Audio API decodeAudioData, FFmpeg, libav or similar.

3. The method of claim 1, wherein the said consecutive audio data blocks are received by the said decoder via network such as through Web Sockets, HTTP, FTP protocols or similar.

4. The method of claim 1, wherein the said consecutive audio data blocks contain audio encoded in a compressed format using a codec such as mp3, aac, flac, speex, ogg or similar that requires for the data to be decoded first for playing back or for encoding into a different format.

5. The method of claim 1, wherein the said audio data is used by itself or in synchronization with video or text.
